(19) United States
(12) Patent Application Publication
(10) Pub. No.: US 2024/0246576 A1
(43) Pub. Date: Jul. 25, 2024

(54) SYSTEMS AND METHODS FOR DETERMINING HANDS-FREE DRIVING OPERATION

(71) Applicant: Honda Motor Co., Ltd., Tokyo (JP)

(72) Inventor: Mark Kisiler, Torrance, CA (US)

(21) Appl. No.: 18/159,503

(22) Filed: Jan. 25, 2023

(51) Int. Cl. B60W 60/00; B60W 40/12; B60W 50/14

(52) U.S. Cl. CPC B60W 60/0051; B60W 40/12; B60W 50/14; B60W 2050/146; B60W 2420/00; B60W 2530/00; B60W 2556/10

(57) ABSTRACT

Provided herein is a system for determining whether hands-free driving operation should be activated. The system is implemented in conjunction with a vehicle, and the system includes a control unit. The control unit is configured to: retrieve historical data associated with hands-free operation of the vehicle, generate, based upon the historical data, an operational map, receive, from the vehicle, current vehicle data, determine, based upon the operational map and the current vehicle data, that hands-free operation is available, and notify the driver that the hands-free operation is recommended.

### BACKGROUND

The present disclosure relates generally to hands-free driving operation of vehicles, and, more specifically, to systems and methods used to determine when hands-free operation of a vehicle should be activated.

As more autonomous driving features are added to vehicles, some drivers may be weary of using the added features and may not trust their vehicle to safely activate the features. Further, many autonomous driving features are activated based only upon current vehicle conditions and may not consider historical driving patterns of drivers of vehicles. As a result, the autonomous driving features may be activated only sporadically, which may add to or create additional doubt for drivers and may further intensify the distrust of drivers in such features. Accordingly, currently available autonomous driving features may not be used to their fullest extent, and as such, the driving experiences of drivers may be limited and not fully enhanced.

### BRIEF DESCRIPTION

In one aspect, a system for determining whether hands-free driving operation should be activated is provided. The system is implemented in conjunction with a vehicle, and the system includes a control unit. The control unit is configured to: retrieve historical data associated with hands-free operation of the vehicle; generate, based upon the historical data, an operational map; receive, from the vehicle, current vehicle data; determine, based upon the operational map and the current vehicle data, that hands-free operation is available; and notify the driver that the hands-free operation is recommended.

In another aspect, a vehicle including a control unit is provided. The control unit is configured to: retrieve historical data associated with hands-free driving mode operation of the vehicle; generate, based upon the historical data, an operational map; receive, from the vehicle, current vehicle data; determine, based upon the operational map and the current vehicle data, whether hands-free driving mode operation is available; and notify the driver that the hands-free operation is recommended.

In yet another aspect, a method for determining whether hands-free driving operation should be activated for a vehicle is provided. The method includes: retrieving, by a control unit of the vehicle, historical data associated with hands-free operation of the vehicle; generating, by the control unit based upon the historical data, an operational map; receiving, by the control unit from the vehicle, current vehicle data; determining, by the control unit based upon the hands-free operation map and the current vehicle data, that hands-free operation is available; and notifying, by the control unit, the driver that the hands-free operation is recommended.

### BRIEF DESCRIPTION OF THE DRAWINGS

FIG. 1 illustrates an exemplary vehicle integrated with an exemplary system for determining hands-free operation.

FIG. 2 is a schematic illustration of a network architecture that may be used with the system shown in FIG. 1.

FIG. 3 is a flow diagram illustrating an exemplary decision tree flowchart that may be executed by the system shown in FIG. 1 in determining hands-free operation.

FIG. 4 illustrates an exemplary hands-free operational map generated by the system of FIG. 1.

FIGS. 5A, 5B, and 5C illustrate exemplary images that may be displayed in a vehicle that includes the system of FIG. 1

FIGS. 6A, 6B, and 6C illustrate exemplary scenarios that may impact the hands-free operation determination of the system of FIG. 1.

### DETAILED DESCRIPTION

The systems and methods described herein are intended to facilitate activation of hands-free operation for a vehicle. Moreover, the systems and methods identify situations where the driver can benefit the most from activation of the hands-free operation. That is, the systems and methods described herein are designed to determine the driving conditions and driving situations in which it is appropriate and safe to implement hands-free operation for the vehicle based upon historical and current data associated with the vehicle. A control unit associated with the vehicle generates an operational map based upon the historical data. The operational map illustrates frequented routes of the driver and whether hands-free operation has been historically and typically activated along the route. The control unit determines, based upon the operational map and the current data, whether hands-free operation is recommended. If the hands-free operation is recommended, the control unit notifies the driver that hands-free operation is recommended and automatically enters hands-free operation or provides a selectable option to the driver that allows the driver to easily instruct the vehicle to enter hands-free operation. Because the systems and methods described herein rely on both historical and current data to determine whether hands-free operation is recommended, hands-free operation of the vehicle is activated in situations wherein the driver will most benefit from and feel most comfortable with hands-free operation. Moreover, by recommending exiting hands-free operation in certain situations that the vehicle automatically detects, the driver's trust in the vehicle's hands-free capability grows.

As used herein, the terms “hands-free operation” and/or “hands-free driving mode(s)” relate to any type of vehicle control system and/or vehicle augmentation system that facilitates enhancing the driving experience and capabilities of a vehicle. For example, vehicle control and augmentation systems may include operating a steering wheel of a vehicle while the vehicle is set on cruise-control, autonomously operating a vehicle while the vehicle is on an interstate or highway, operating the vehicle in a fully autonomous or “self-driving” mode (e.g., where a driver inputs a location for the vehicle and the vehicle drives to the location without assistance from the driver), and any other vehicle control or augmentation system.

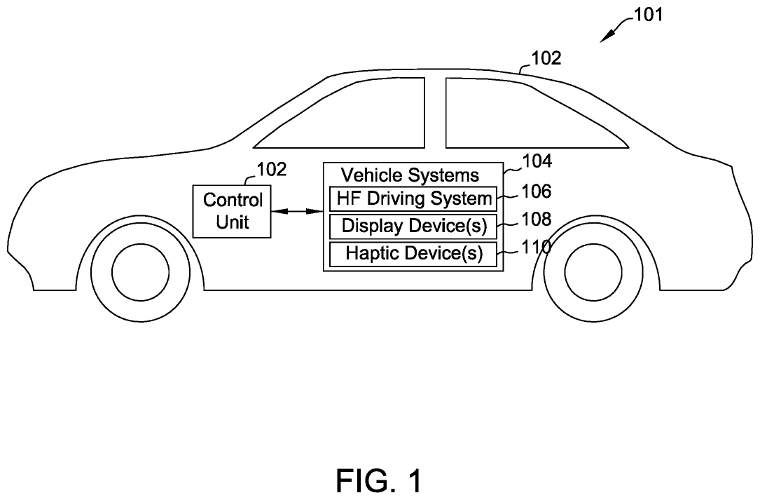

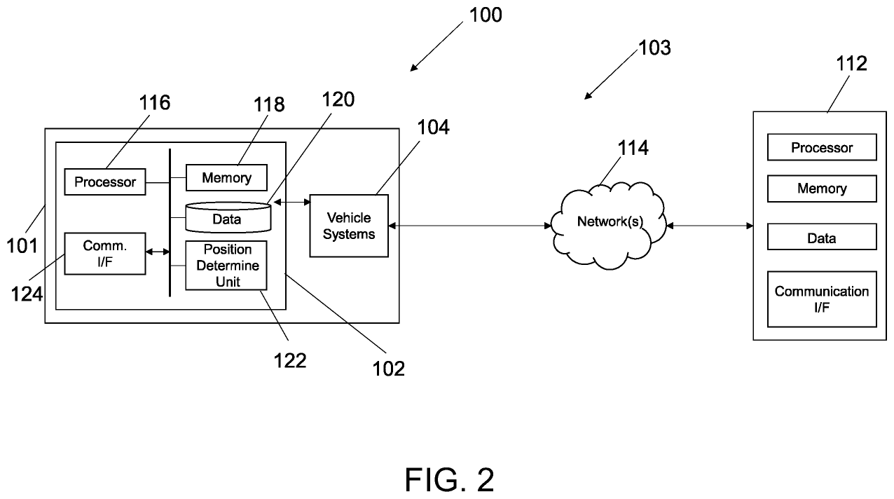

Referring now to the drawings, FIG. 1 is an exemplary vehicle 101 integrated with an exemplary system 100 for use in determining hands-free operation. FIG. 2 is a schematic illustration of a network architecture 103 that may be used with system 100. In the exemplary embodiment, system 100 is configured to determine when it is appropriate and safe to implement hands-free operation for vehicle 101, as described in more detail herein. System 100 can be implemented with the components shown in FIG. 1, but is not limited to only being implemented with the components illustrated in FIG. 1. For convenience, identical names and numerals are used in FIG. 2 to identify the same components identified in FIG. 1.

Referring to FIG. 1, in the exemplary embodiment, vehicle 101 includes a control unit 102 and a plurality of vehicle systems 104. Vehicle systems 104 can include any type of vehicle control system and/or augmentation system that facilitates enhancing the driving experience and capabilities of vehicle 101. In the exemplary embodiment, vehicle systems 104 include at least a hands-free (HF) driving system 106, one or more display devices 108, and at least one haptic device 110.

Alternatively, systems 104 may include any or all of the devices described herein, and/or in addition may include other systems and/or devices that enable vehicle 101 to be operated in a hands-free driving mode, as described herein. For example, hands-free driving system 106 may include any autonomous driving systems, driver-assist systems, adaptive cruise control systems, lane departure warning systems, merge assist systems, freeway merging, exiting, and lane-change systems, collision warning systems, integrated vehicle-based safety systems, and automatic guided vehicle systems, and/or any other advanced driving assistance systems (ADAS).

Display device 108 may include any device that is configured to display information to a driver of vehicle 101, or in the case of hands-free driving, display information to a person seated in the driver's seat. For example, display device 108 may include a dashboard display configured to display one or more vehicle properties to the driver of vehicle 101, including, for example, a speed of vehicle 101, revolutions per minute of an engine or drivetrain of vehicle 101, a relative temperature of an engine or drivetrain of vehicle 101, a status display of the current operation state of the vehicle 101 and/or a status display of the hands-free operation of vehicle 101, vehicles surrounding vehicle 101 and/or obstructions in close proximity to vehicle 101, alerts associated with vehicle 101, and any other vehicle properties. Haptic device 110 may include any devices within vehicle 101 that produce haptic feedback (e.g., vibrations) to a person seated in the driver's seat of vehicle 101. For example, haptic devices 110 may be included in a steering wheel of vehicle 101, in one or more pedals of vehicle 101, and/or in one or more seats of vehicle 101.

Referring now to FIG. 2, vehicle 101 and a remote server 112 are each operatively coupled together to enable communication therebetween. For example, vehicle 101 and any surrounding vehicles that are integrated with a hands-free driving system may communicate with each other via a network 114, or may be capable of communicating directly with each other via a wireless network (not shown). For simplicity, only one vehicle 101 is illustrated in FIG. 2. However, it should be understood that additional vehicles can be integrated with and include any of the components and/or functions described herein with respect to vehicle 101. Further, it should also be understood that the components of vehicle 101 and the remote server 112, as well as the components of other systems, hardware architectures, and software architectures discussed herein, can be combined, omitted, and/or organized into different architectures for various embodiments, without changing the scope of the disclosure.

In the exemplary embodiment, vehicle 101 includes a controller or control unit 102 and vehicle systems 104. Generally, controller 102 includes a processor 116, a memory 118, a data storage 120, a position determination unit 122 (labeled “position determine unit” in FIG. 2), and a communication interface (I/F) 124 (i.e., a transceiver 124), all of which are operably coupled for communication via a bus and/or other wired and/or wireless technologies discussed herein. Control unit 102 can include provisions for processing, communicating, and interacting with various components of vehicle 101 and other components of system 100, including any other vehicles within communicative proximity, and remote server 112.

Processor 116 includes logic circuitry with hardware, firmware, and software architecture frameworks that enable processing by vehicle 101 and that facilitate communication between any other vehicles and remote server 112. Processor 116 is programmed with an algorithm that enables a determination of whether to allow hands-free operation of vehicle 101, as described in more detail below. Thus, in some embodiments, processor 116 can store application frameworks, kernels, libraries, drivers, application program interfaces, among others, to execute and control hardware and functions discussed herein. In some embodiments, memory 118 and/or the data storage 120 (e.g., a disk) can store similar components as processor 116 for execution by processor 116.

In the exemplary embodiment, position determination unit 122 includes hardware (e.g., sensors) and software that determine and/or acquire positional data associated with vehicle 101. For example, position determination unit 122 can include a global positioning system (GPS) unit (not shown) and/or an inertial measurement unit (IMU) (not shown). Thus, position determination unit 122 can provide location data (e.g., geo-positional data) associated with vehicle 101 based on satellite data received from, for example, a global position source unit, or from any Global Navigational Satellite infrastructure (GNSS), including, but not limited to GPS, Glonass (Russian) and/or Galileo (European). Further, position determination unit 122 can provide dead-reckoning data or motion data from, for example, a gyroscope, accelerometer, magnetometers, among other sensors (not shown). That is, position determination unit 122 may be used to determine a current location and current speed of vehicle 101. In some embodiments, position determination unit 122 can be a navigation system that provides navigation maps, map data, and navigation information to vehicle 101 to facilitate navigation of hands-free operation zones, for example.

Communication interface (I/F) 124 can include software and hardware to facilitate data input and output between the components of control unit 102 and other components of system 100. Specifically, communication I/F 124 can include network interface controllers (not shown) and other hardware and software that manages and/or monitors connections and controls bi-directional data transfer between communication I/F 124 and other components of system 100 using, for example, network 114. In particular, communication I/F 124 can facilitate communication (e.g., exchange data and/or transmit messages) with other vehicles and/or devices, using any type of communication hardware and/or protocols discussed herein. For example, the computer communication can be implemented using a wireless network antenna (e.g., cellular, mobile, satellite, or other wireless technologies) or road-side equipment (RSE) (e.g., Dedicated Short Range Communications or other wireless technologies), and/or network 114. Further, communication I/F 124 can also include input/output devices associated with the respective vehicle, such as a mobile device. In some embodiments described herein, communication between vehicles can be facilitated by displaying and/or receiving communication on a display within the respective vehicle.

As described above with respect to FIG. 1, vehicle systems 104 can include any type of vehicle control system and/or system that facilitates enhancing the driving experience of vehicle 101.

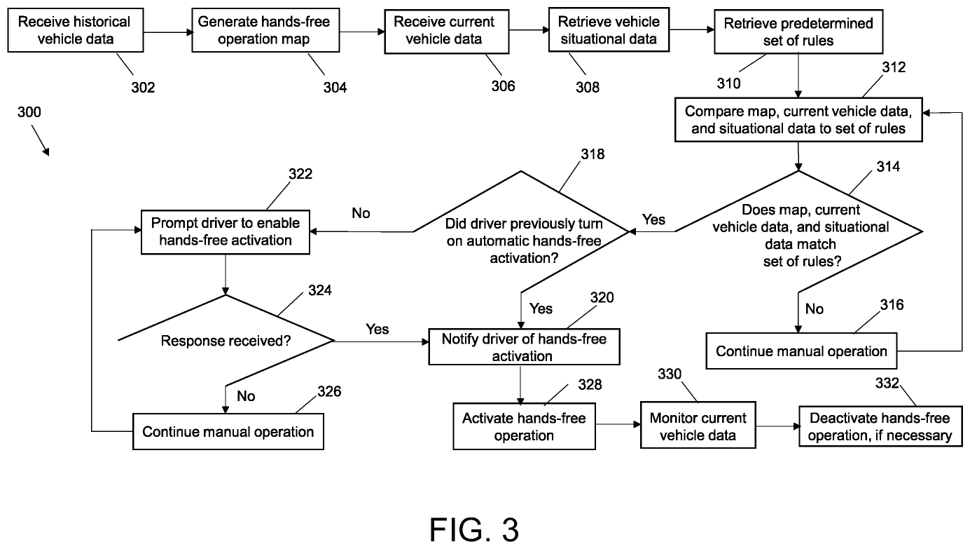

With reference to FIG. 3, a flow diagram illustrating an exemplary decision tree flowchart 300 that may be executed by system 100 (shown in FIGS. 1 and 2) in determining whether to activate hands-free operation for vehicle 101. In the exemplary embodiment, flowchart 300 is described using the operations of one or more components of system 100, such as control unit 102 and vehicle systems 104, for example. Further, while flowchart 300 is described herein for use with one vehicle 101, it should be understood that flowchart 300 and its associated methodology can be used within a plurality of different vehicles and for a plurality of different hands-free or autonomous driving modes, as described herein.

Initially, in the exemplary embodiment, system 100 receives 302 historical vehicle data from vehicle 101. The historical vehicle data may be received 302 from memory 118 (shown in FIG. 2), for example, and may include any of historical routes and driving patterns, historical vehicle operating speed data, historical vehicle-to-vehicle communication data, historical hands-free operation data, and/or any other historical vehicle data. System 100 uses the historical vehicle data to generate 304 a hands-free operation map (also referred to herein as an “operational map”). The hands-free operation map may include a detailed map of areas surrounding frequented locations of vehicle 101 (e.g., a home and/or a workplace of a driver of vehicle 101) and include indications of hands-free operation zones within the map. The hands-free operation zones may be areas within the map in which hands-free operation is frequently activated by control unit 102 and/or the driver of vehicle 101, and/or areas wherein other vehicles augmented with their own system 100 have frequently activated their own hands-free operation. The generated 304 hands-free operation maps may vary according to the time of day in which vehicle 101 is driven, the season in which vehicle 101 is driven, and other factors. For example, if the driver of vehicle 101 typically leaves for work early in the morning before rush-hour traffic begins, the generated 304 hands-free operation map may show that the driver's route to work is almost entirely a hands-free operation zone. However, if a driver of vehicle 101 typically leaves for work during rush-hour traffic, the generated 304 hands-free operation map may show that almost none of the driver's route to work is typically a hands-free operation zone, i.e., the generated 304 may show that most of the driver's route to work is a manual operation zone wherein hands-free operation is not frequently activated. Further, the hands-free operation map may be generated using received 302 historical vehicle data of many vehicles, not just the historical vehicle data of vehicle 101.

System 100 then receives 306 current vehicle data of vehicle 101. The received 306 current vehicle data of vehicle 101 may be received 306 in real-time, near-real-time, and/or in any predetermined time period from any components of vehicle 101. For example, the current vehicle data may include location data from a location sensor included in position determination unit 122 (shown in FIG. 2), vehicle proximity data from transceiver 124 (shown in FIG. 2), and/or speed data from an accelerometer or speedometer included in position determination unit 122. The received 306 current vehicle data may also include any additional relevant vehicle data. Based upon the received 306 current vehicle data, system 100 retrieves 308 vehicle situational data including, for example, weather and traffic data for an area surrounding the current location of vehicle 101.

The vehicle situational data may be retrieved via control unit 102 from one or more weather and traffic databases over network 114 (shown in FIG. 2). Similarly to the access of the current vehicle data, the vehicle situational data may be retrieved 308 in real-time, near-real-time, or in any predetermined time period. System 100 also retrieves 310 a predetermined set of rules for hands-free operation of vehicle 101. The predetermined set of rules may include, for example, acceptable and/or unacceptable weather conditions to operate vehicle 101 in a hands-free driving mode, acceptable and/or unacceptable vehicle speed limitations to enable vehicle 101 to be operated in the hands-free driving mode, and/or vehicle proximities acceptable and/or unacceptable to enable vehicle 101 to be operated in the hands-free driving mode. The predetermined rules may be set by the driver of vehicle 101 and/or the predetermined rules may be pre-set by system 100. For example, system 100 may set the predetermined rules to be that the hands-free driving mode of vehicle 101 should be enabled when hands-free operation map shows a hands-free operation zone, and the hands-free driving mode of vehicle should be deactivated when hands-free operation map shows a manual operation zone. The driver of vehicle 101 may indicate and establish (e.g., through input via display device 108, shown in FIG. 1, of vehicle 101), in the predetermined rules, that the hands-free driving mode of vehicle 101 should not be enabled to be activated when, for example, (i) any precipitation is forecasted within a pre-defined area around the current location, (ii) an operating speed of the vehicle is below 45 miles per hour (MPH), and/or (iii) there are vehicles within two vehicle lengths of vehicle 101.

After the current vehicle data, vehicle situational data, and predetermined set of rules are received/retrieved 306, 308, and 310 by system 100, system 100 compares 312 the generated 304 hands-free operation map, current vehicle data, and vehicle situational data to the predetermined set of rules. If it is determined 314 that the hands-free operation map, current vehicle data, and vehicle situational data do not satisfy any of the predetermined set of rules, system 100 continues 316 manual operation of vehicle 101, and the flowchart analysis 300 restarts again by again determining 314 if any of the predetermined operating criteria are satisfied. If it is determined 314 that each of the hands-free operation map, current vehicle data, and vehicle situational data match the predetermined set of rules, system 100 continues the flowchart analysis 300.

After determining 314 that all of the predetermined operating criteria are satisfied, system 100 determines 318 whether the driver of vehicle 101 previously turned on automatic hands-free activation. For example, the driver of vehicle 101 may select to always have the hands-free driving mode of vehicle 101 activated as the predetermined set of rules, i.e., operating criteria, are satisfied, or alternatively, the driver of vehicle 101 may elect to only activate the hands-free driving mode of vehicle 101 when the driver is prompted and desires to place the vehicle 101 into the hands-free driving mode of vehicle 101. If it is determined 318 that the driver had previously turned on automatic hands-free activation of vehicle 101, flowchart analysis 300 continues and the driver is notified 320 that the vehicle 101 is about to enter the hands-free driving mode. If, however, it is determined 318 that the driver had not previously elected the automatic hands-free driving mode of vehicle 101, system 100 may prompt 322 the driver to enable the hands-free driving mode of vehicle 101 if the driver desires it. System 100 then awaits feedback, i.e., an input from the driver, and determines 324 whether the driver has responded to the prompt 322. If it is determined 324 that the driver has not responded to the prompt 322 and/or has not activated hands-free activation of vehicle 101, manual operation of vehicle 101 is continued 326. However, if it is determined 324 that the driver has elected to activate the hands-free driving mode, and has responded to the prompt 322, flowchart analysis 300 continues and activates 328 the hands-free driving mode for vehicle 101.

When system 100 notifies 320 the driver of hands-free activation of vehicle 101, system 100 may notify 320 the driver by displaying, on display device 108 (shown in FIG. 1) of vehicle 101, a countdown clock showing an amount of time until the hands-free driving mode is activated and/or activate haptic devices 110 (shown in FIG. 1) included in the seat, pedals, and/or steering wheel of vehicle 101. Such notifications 320 provide the driver with enough time to respond to the hands-free driving mode activation, such as removing their hands from the steering wheel and/or their feet off the pedals, or providing enough time for the driver to cancel the activation if desired.

After system 100 has notified 320 the driver of vehicle 101 that the hands-free operation will be activated, system 100 automatically activates 328 the hands-free driving mode of vehicle 101. System 100 then continuously monitors 330 the current vehicle data and vehicle situational data. More specifically, the system 100 continuously monitors 330 the current vehicle data and vehicle situational data by comparing 312 the current vehicle data and vehicle situational data to the hands-free operation map and the predetermined set of rules/operating criteria to ensure that vehicle 101 can and should stay in hands-free operation. If system 100 determines that vehicle 101 should not be operated in hands-free operation (e.g., if system 100 determines that the vehicle 101 is traveling into an area of high traffic and/or inclement weather, or if the vehicle 101 is traveling out of the hands-free operation zone based on the initial hands-free operation map generated 304, system 100 deactivates 332 hands-free operation, as necessary. In the exemplary embodiment, system 100 notifies the driver of vehicle 101 that hands-free operation is being deactivated 332 in the same or similar manner as the notifications 320 provided to the driver when the hands-free driving system was about to be activated 328.

As shown and described with respect to FIG. 3, flow diagram 300 ensures that hands-free operation is activated for the driver of vehicle 101 in driving situations when the driver can most benefit from hands-free operation of vehicle 101. That is, in the exemplary embodiment, flow diagram 300 considers historical data, current condition data, and predetermined rules received from the driver, before determining that hands-free operation of vehicle 101 is safe and appropriate to activate. Accordingly, flow diagram 300 facilitates enhancing the driving experience for the driver of vehicle 101.

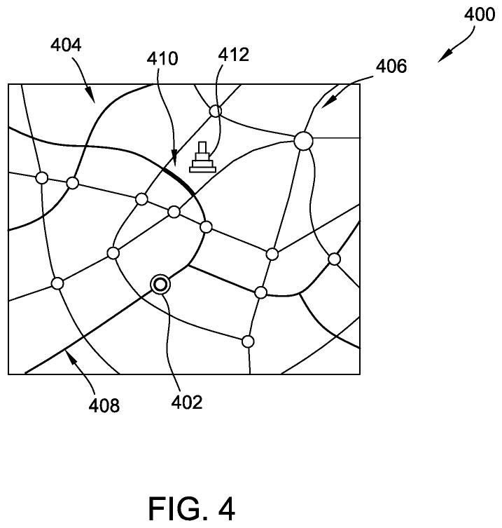

Referring now to FIG. 4, an exemplary hands-free operation map 400, also referred to as an “operational map” herein, is shown. Map 400 may be generated by system 100 (shown in FIGS. 1 and 2), as described with respect to FIGS. 1-3 herein. Moreover, and as also described herein, map 400 may be displayed on a display device 108 within vehicle 101 (both shown in FIG. 1) and/or stored in a memory 118 of control unit 102.

In the exemplary embodiment, map 400 illustrates a current location 402 of a vehicle (e.g., vehicle 101, shown in FIGS. 1 and 2), as well as highlighted routes 404 and other roads 406. In the exemplary embodiment, highlighted routes 404 are those roads that system 100 determines, based upon historical data, that the driver typically or frequently travels. For example, highlighted routes 404 may include the daily commute path of the driver and/or typical paths to other locations that the driver frequents including, for example, houses of friends or family, restaurants, the gym of the driver, etc. In the illustrated embodiment, the highlighted routes 404 are shown in a more pronounced manner than the other roads 406 included on map 400.

Map 400 also includes suggested areas for hands-free operation zones 408 and areas of manual operation zones 410, i.e., areas in which hands-free operation is not recommended. In the illustrated embodiment, hands-free operation zones 408 are illustrated with dark, solid lines, and manual operation zones 410 are shown with striped lines. As described herein, hands-free operation zones 408 are routes in which the hands-free operation of vehicle 101 is typically activated, and manual operation zones 410 are routes in which manual operation is typically necessary, and hands-free operation is therefore deactivated. In the exemplary embodiment, system 100 determines what metrics are necessary for a zone to be identified as a hands-free operation zone 408 or as a manual operation zone 410. For example, system 100 may determine that a given area is a hands-free operation zone if the hands-free operation mode is historically activated more than 60% of the time vehicle 101 is in the zone, and the system may label everything else as a manual operation zone 410. In one embodiment, the system may receive inputs from vehicle 101, from the driver of vehicle 101, and/or from other vehicles coupled to the system that travel through the same areas. In other words, in such an embodiment, if it is common for other vehicles to be in hands-free driving modes in specific areas, system 100 may identify such areas as hands-free zones 408 even if the driver or vehicle 101 has not traveled through such a zone previously. In other embodiments, the driver may set thresholds for what is determined to be a hands-free operation zone 408 or a manual operation zone 410. For example, the driver may set the thresholds for map 400 in the predetermined rules described herein, such as inputs regarding travel speeds, current traffic speeds in such areas, current weather in such areas, and/or the type of roads in the area, i.e., two-lane roads, four-lane highways, etc.

In the exemplary embodiment, map 400 is dynamic based upon data received by system 100. For example, in the illustrated embodiment, the only manual operation zone 410 illustrated includes a construction indicator 412 in zone 410. System 100 may have determined, based upon historical data and/or current traffic data, that construction is taking place in manual operation zone 410 and may therefore include indicator 412 by manual operation zone 410 to show the driver why that route is being identified as manual operation zone 410. In some embodiments, map is dynamically updated based on inputs received from other vehicles communicatively coupled to system 100.

After system 100 determines that construction is no longer taking place, indicator 412 may be removed, and that route may be determined by system 100 to be a hands-free operation zone 408. Other indicators that may be included in map 400 may include indicators that an accident has taken place, indicators of emergency services vehicle, and indicators of weather. These other indicators and their corresponding conditions may lead map 400 to include different hands-free operation zones 408 or manual operation zones 410. For example, if system 100 determines that the current weather conditions around current location 402 are sleet and snow, system 100 may turn all of highlighted routes 404 into manual operation zones 410 due to the inclement weather.

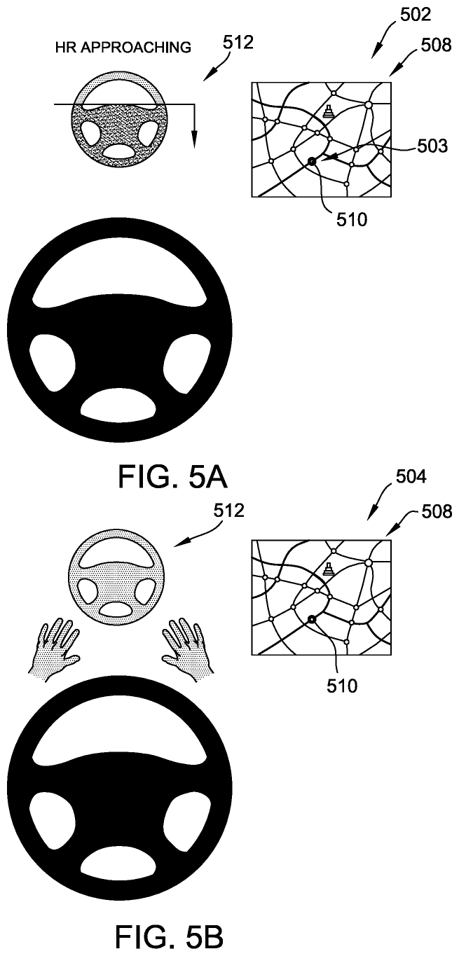

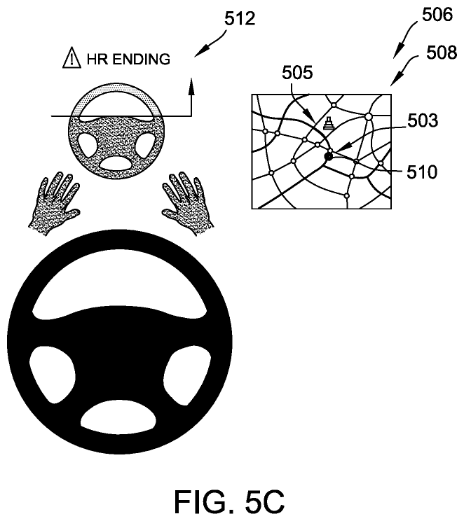

Referring now to FIGS. 5A, 5B, and 5C, exemplary displays 502, 504, and 506 of a vehicle (e.g., vehicle 101, shown in FIG. 1) are illustrated. Displays 502, 504, and 506 may be displayed on display device 108 (shown in FIG. 1) of vehicle 101 in different hands-free operation statuses. Specifically, display 502 may be displayed via display device 108 when a hands-free operation zone 503 is approaching, and system 100 (shown in FIG. 2) is preparing to automatically activate hands-free operation of vehicle 101. Display 504 may be displayed via display device 108 when hands-free operation of vehicle 101 is activated, and display 506 may be displayed via display device 108 when hands-free operation zone 503 is ending, and system 100 is preparing to automatically deactivate hands-free operation of vehicle 101. In some embodiments, the driver of vehicle 101 may also receive an audible warning in addition to a visual warning when a hands-free operation is being deactivated by system 100.

Each display 502, 504, 506 also includes an operational map 508 indicating a current location 510 of vehicle 101 and a hands-free operation status 512. Map 508 may be substantially similar to map 400 (shown in FIG. 4). That is, map 508 may identify to the driver of vehicle 101 hands-free operation zones 503 and manual operation zones 505 determined by system 100. Hands-free operation status 510 may be dependent on map 508 and/or current conditions of vehicle 101, as determined by system 100 and described herein. For example, although map 508 may display current location 510 of vehicle 101 to be within hands-free operation zone 503, the hands-free operation status 510 may display that hands-free operation is deactivated. The discrepancy may occur for example, if system 100 determines that too many other vehicles are around or in close proximity to vehicle 101, if the speed of vehicle 101 is too slow compared to a speed limit of the route or is not satisfying a pre-determined range of threshold speeds, and/or if inclement weather is on the route of vehicle 101.

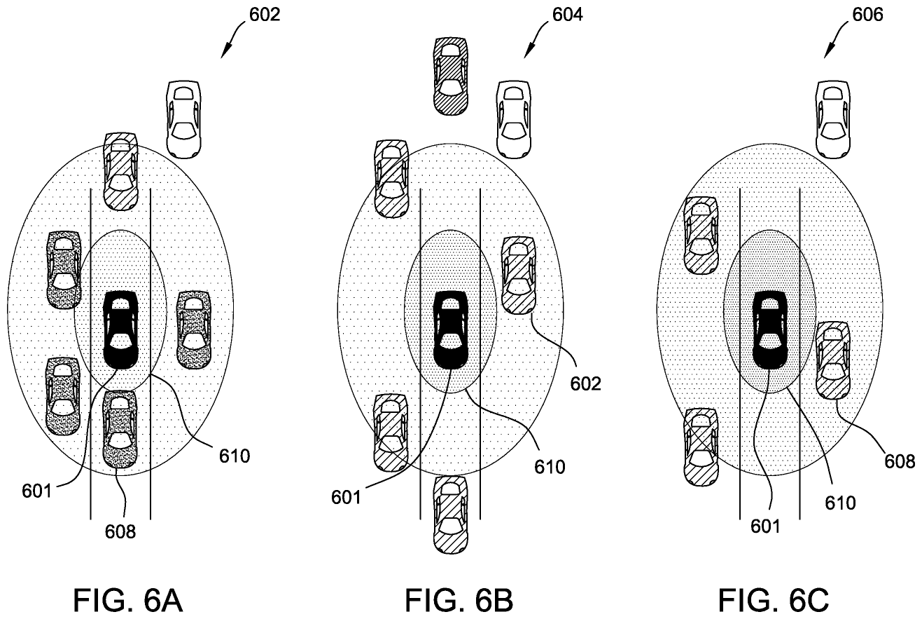

Referring now to FIGS. 6A, 6B, and 6C, exemplary scenarios 602, 604, and 606 in which hands-free operation of a vehicle 601 is not activated or activated are illustrated. In the exemplary embodiments, vehicle 601 may be substantially similar to vehicle 101 (shown in FIG. 1). In each scenario 602, 604, 606, system 100 (shown in FIGS. 1 and 2) determines whether to activate the hands-free operation mode of vehicle 601 based upon the surroundings of vehicle 601 and current data related to the surroundings.

In the exemplary embodiment, system 100 may determine whether one or more other vehicles 608 are within a pre-defined area of radius 610 around vehicle 601. Radius 610 may be set by system 100 and/or may be input by the driver of vehicle 601 (e.g., in the predetermined rules, as described herein). System 100 may determine the proximity of other vehicle 608 to vehicle 601 through, for example, vehicle-to-vehicle communication between vehicle 601 and other vehicles 608, and/or through proximity sensors included within vehicle 601. System 100 may also factor other data related to the current situation of vehicle 601, such as but not limited to, a current speed of vehicle 601, relative operating speeds of other vehicles in the area, traffic data surrounding the current location of vehicle 601, etc.

In scenario 602, the hands-free operation mode of vehicle 601 is not recommended because other vehicles 608 are traveling within the pre-defined radius 610 of vehicle 601. If vehicle 601 is actively in a hands-free operation mode and scenario 602 arises, it will be recommended (e.g., by system 100) that a driver of vehicle 601 exit the hands-free operation mode. If vehicle 601 is not actively in the hands-free operation mode and scenario 602 arises, system 100 will not recommend the driver of vehicle 601 enter the hands-free operation mode. In scenario 604, the hands-free operation mode of vehicle 601 is recommended because other vehicles 608 are not within the pre-defined radius 610 of vehicle 601. If vehicle 601 is actively in the hands-free operation mode and scenario 604 arises, system 100 will continue to recommend that vehicle 601 stay in the hands-free operation mode. If vehicle 601 is not actively in the hands-free operation mode and scenario 604 arises, system 100 will recommend to the driver of vehicle 601 to enter into hands-free operation mode. In scenario 606, the hands-free operation mode of vehicle 601 is also activated because other vehicles 608 are not within the pre-defined radius 610 of vehicle 601. If vehicle 601 is actively in the hands-free operation mode and scenario 606 arises, system 100 will continue to recommend that vehicle 601 stay in the hands-free operation mode. If vehicle 601 is not actively in the hands-free operation mode and scenario 606 arises, system 100 will recommend to the driver of vehicle 601 to enter into hands-free operation mode. In both scenarios 604 and 606, system 100 may communicate with and monitor other vehicles 608 to ensure that other vehicles 608 do not enter the pre-defined radius 610 of vehicle 601. For example, in scenario 604 where other vehicles 608 are in proximity to and around vehicle 601, system 100 may deactivate the hands-free driving mode of vehicle 601 quickly if any other vehicle 608 travels within the pre-defined radius 610 of vehicle 601.

The embodiments described herein relate generally to systems and methods to facilitate activation of hands-free operation for a vehicle. In the exemplary embodiments, a control unit of a vehicle utilizes at least historical data and current data associated with the vehicle, as well as potentially other vehicles coupled to the same system, to determine whether it is safe and appropriate to activate a hands-free operation mode of the vehicle. The control unit continuously monitors the current vehicle data and deactivates the hands-free operation mode of the vehicle if necessary. Accordingly, the systems and methods described herein facilitate activating hands-free operation of the vehicle in situations where the driver most benefits from hands-free operation, further enhancing the driving experience of the driver.

Exemplary embodiments of a hands-free operation determination system are described above in detail. Although the system herein is described and illustrated in association with a single vehicle, the system could be used to determine whether hands-free operation should be activated for a plurality of vehicle based upon aggregated historical data for the plurality of vehicles, for example. Moreover, it should also be noted that the components of the disclosure are not limited to the specific embodiments described herein, but rather, aspects of each component may be utilized independently and separately from other components and methods described herein.

This written description uses examples to disclose various embodiments, including the best mode, and also to enable any person skilled in the art to practice the various implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for determining whether hands-free driving operation should be activated, the system implemented in conjunction with a vehicle, the system comprising:
a control unit configured to:
retrieve historical data associated with hands-free operation of the vehicle;
generate, based upon the historical data, an operational map;
receive, from the vehicle, current vehicle data;
determine, based upon the operational map and the current vehicle data, that hands-free operation is recommended; and
notify the driver that the hands-free operation is recommended.

2. The system in accordance with claim 1, wherein the control unit is further configured to automatically activate the hands-free driving operation when the hands-free operation is recommended.

3. The system in accordance with claim 1, wherein the vehicle further includes at least one of a transceiver, an accelerometer, a speedometer, a display visible by a person seated in the driver's seat of the vehicle, and at least one haptic device.

4. The system in accordance with claim 3, wherein the vehicle further includes a location sensor and at least one vehicle proximity sensor, and wherein the current vehicle data includes at least location data received from the location sensor, vehicle proximity data received from the vehicle, and vehicle operational speed data received from at least one of the accelerometer and the speedometer.

5. The system in accordance with claim 4, wherein the control unit is further configured to receive weather data and traffic data based upon the location data of the vehicle.

6. The system in accordance with claim 5, wherein the control unit is further configured to:
retrieve predetermined operating criteria rules to enable the hands-free operation of the vehicle, wherein the predetermined rules include at least one of weather conditions where operating the vehicle in a hands-free driving operation mode is recommended, vehicle operating speeds where operating the vehicle in the hands-free driving operation mode is recommended, and vehicle proximities that are acceptable to operate the vehicle in the hands-free driving operation mode.

7. The system in accordance with claim 6, wherein the control unit is further configured to:
compare the current vehicle data to the operational map and the predetermined operating criteria rules;
determine, based upon the comparison, that the hands-free driving operation mode for the vehicle is available; and
activate the hands-free operation of the vehicle.

8. The system in accordance with claim 7, wherein the control unit is further configured to:
notify the driver that the hands-free operation is activated by providing feedback to the driver through at least one of the display and the at least one haptic device.

9. The system in accordance with claim 6, wherein the control unit is further configured to:
continuously monitor the current vehicle data by comparing the current vehicle data to the operational map and the predetermined operating criteria rules; and
based upon the comparison, deactivate the hands-free operation of the vehicle.

10. The system in accordance with claim 9, wherein the control unit is further configured to:
notify the driver that the hands-free operation is deactivated through at least one of the display and the at least one haptic device.

11. The system in accordance with claim 3, wherein the control unit is further configured to:
display, on the display of the vehicle, the operational map and a current status of the availability of a hands-free driving operation mode.

12. A vehicle comprising:
at least one sensor, wherein the at least one sensor includes a vehicle location sensor, a vehicle proximity sensor, an accelerometer, and/or a speedometer;
a transceiver configured to receive traffic and weather data based upon location data of the vehicle; and
a control unit, wherein the control unit is configured to:
retrieve historical data associated with hands-free driving mode operation of the vehicle;
generate, based upon the historical data, an operational map;
receive, from the vehicle, current vehicle data;
determine, based upon the operational map and the current vehicle data, whether hands-free driving mode operation is available; and
notify the driver that the hands-free operation is recommended.

13. The system in accordance with claim 12, wherein the control unit is further configured to automatically activate the hands-free driving operation when the hands-free operation is recommended.

14. The vehicle in accordance with claim 12, wherein the current vehicle data includes at least the location data received from the vehicle location sensor, vehicle proximity data received from the vehicle proximity sensor, and vehicle operational speed data received from at least one of the accelerometer and the speedometer.

15. The vehicle in accordance with claim 12, wherein the control unit is further configured to:
retrieve predetermined operating criteria rules to enable the hands-free operation of the vehicle, wherein the predetermined rules include at least one of weather conditions that are acceptable to operate the vehicle in a hands-free driving operation mode, vehicle operating speeds that are acceptable to operate the vehicle in the hands-free driving operation mode, and vehicle proximities that are acceptable to operate the vehicle in the hands-free driving operation mode.

16. The vehicle in accordance with claim 15, wherein the control unit is further configured to:
compare the current vehicle data to the operational map and the predetermined operating criteria rules;
determine, based upon the comparison, that the hands-free driving operation mode for the vehicle is recommended; and
activate the hands-free operation of the vehicle.

17. A method for determining whether hands-free driving operation should be activated for a vehicle, the method comprising:
retrieving, by a control unit of the vehicle, historical data associated with hands-free operation of the vehicle;
generating, by the control unit based upon the historical data, an operational map;
receiving, by the control unit from the vehicle, current vehicle data;
determining, by the control unit based upon the hands-free operation map and the current vehicle data, that hands-free operation is available; and
notifying, by the control unit, the driver that the hands-free operation is recommended.

18. The method in accordance with 17 further comprising:
determining, by the control unit, a location of the vehicle based upon location data of the vehicle; and
retrieving, by the control unit, weather data and traffic data based upon the location data of the vehicle.

19. The method in accordance with claim 17 further comprising:
retrieving, by the control unit, predetermined operating criteria rules to enable the hands-free operation of the vehicle, wherein the predetermined rules include at least one of weather conditions that are acceptable to operate the vehicle in a hands-free driving operation mode, vehicle operating speeds that are acceptable to operate the vehicle in the hands-free driving operation mode, and vehicle proximities that are acceptable to operate the vehicle in the hands-free driving operation mode.

20. The method in accordance with claim 19 further comprising:
comparing, by the control unit, the current vehicle data to the operational map and the predetermined operating criteria rules;
determining, by the control unit based upon the comparison, that the hands-free driving operation mode for the vehicle is recommended; and
activating, by the control unit, the hands-free operation of the vehicle.
